(19) United States
(12) Patent Application Publication
(10) Pub. No.: US 2026/0222301 A1
(43) Pub. Date: Jul. 30, 2026

(54) SYSTEM AND METHOD FOR MANAGEMENT OF CONSTRAINED IOT DEVICES

(71) Applicant: British Telecommunications Public Limited Company, London Greater London (GB)

(72) Inventor: Evandro PIOLI MORO, London Greater London (GB)

(21) Appl. No.: 19/143,319

(22) PCT Filed: Dec. 8, 2023
(86) PCT No.: PCT/EP2023/084974

§ 371 Date: Jun. 25, 2025

(30) Foreign Application Priority Data
Dec. 28, 2022 (EP) 22216962.5
Dec. 28, 2022 (GB) 2219781.8

(51) Int. Cl. H04L 41/12; H04L 9/00

(52) U.S. Cl. CPC H04L 41/12; H04L 9/50

(57) ABSTRACT

The present disclosure relates to a method and system for management of constrained internet of things (IoT) devices. In particular, the present disclosure relates to a method and system for management of data transmitted by an IoT device by using digital twinning and distributed ledger technology.

The present disclosure relates to a method and system for management of constrained internet of things (IoT) devices. In particular, the present disclosure relates to a method and system for management of data transmitted by an IoT device by using digital twinning and distributed ledger technology.

Given the unprecedented increase in the number of Internet of Things (IoT) devices over the past decade and the growing importance of IoT in IT infrastructures, ensuring the security of IoT devices is at the centre of numerous research projects of the Information and Communications Technology (ICT) industry and academia, and a valuable market niche.

The design constraints and low computational power of IoT devices can make them an easy target for cyber-attacks. Traditional IT security mechanisms designed for computers, servers and systems are based in a three-layer defence structure: static perimeter network layer (i.e. firewalls, intruder detection systems), end-host defence tools (e.g. antivirus software) and software patches (i.e. re-deployment of security packages on a regular basis).

However, such a traditional security structure is not well suited to IoT devices, where software processing and network communications should be kept at a minimum. More specifically, different use cases require different types of IoT structures and security levels, thus generic IT security systems are difficult to implement for these cases and often not flexible enough. Given this challenge, there has been research into the area of improved security for IoT devices [1-3]. Despite the existing research, there is still a need for an efficient and more secure method and system for management of IoT devices.

Embodiments of the present disclosure relate to providing a more secure and efficient method and system for management of constrained internet of things (IoT) devices.

The inventors have recognized the need to improve the management of IoT devices by providing security at a scale focusing on battery and computing power of constrained IoT devices. The inventors have proposed to combine the advantages of digital twinning (DT) and distributed ledger technologies (DLT) in order to achieve this objective. Digital twin services can be used to satisfy the interaction requirements placed on physical devices in a more efficient and scalable way. DLT (for example, blockchain) provides improved security given the immutability, enhanced fault tolerance, auditability, transparency, and decentralized trust provision associated with this technology.

The present invention has the advantage of reducing the networking requirements of IoT devices by performing heavy security operations on a cloud service. The proposed cloud operations include characteristics of data integrity, provenance, and immutability associated with DLTs, thereby providing a more secure method of managing IoT devices.

Digital twinning is defined as a method for turning physical devices into digital services. DTs can be used to model and digitize assets, processes, and systems. DTs can be used to satisfy the interaction requirements placed on physical devices in a more efficient and scalable way as any querying operations are performed on the DTs rather than the physical IoT device itself. Application Programming Interfaces (APIs) allow control and access to the DTs either by direct communication or to replicate this behaviour if the devices are not online or only send data periodically.

DLT is a peer-to-peer networking system where a ledger of transactions is synchronized among peers. If the transactions ledger is immutable and structured in the form of blocks of information linked to the previous blocks via a hashing operation, then the DLT is called a blockchain.

An important feature of blockchains is the implementation of smart contracts. Smart contracts are pieces of code executed in a decentralized fashion by all nodes of the network. They provide programmability to the system, are able to react to inputs and to the blockchain state and produce the program output at all nodes for the system. Smart contracts are pieces of code triggered either by conditions set, i.e. reacting to a certain blockchain state, or by a call from any node via a transaction. They can perform various functions in a blockchain system, for example, enabling an agreement between two or more parties, to provide virtual identities for devices, to check authorization of nodes, to transfer digital assets, among others.

Since smart contracts reside on the blockchain, they must have an associated address, which is used to collect the funds in exchange of their execution. Moreover, smart contract scripts are inheritably deterministic, meaning that it will always provide the same outputs for the same inputs. Furthermore, all interactions with the smart contract will be supported by cryptographically signed messages registered on the ledger, meaning all smart contract interactions are traceable and auditable. These factors are what make smart contracts so important for current distributed ledgers implementations.

IoT devices are physical objects with sensors, processing ability, software, and other technologies that connect and exchange data with other devices and systems over the Internet or other communications networks.

According to a first aspect of the disclosure, a computer-implemented method is provided for managing data transmitted by at least one IoT device via a network gateway in a communication network, the method comprising: providing, by the network gateway, a first data transmitted by the IoT device to a distributed ledger; assigning, by the distributed ledger, a first unique identifier to the first data; applying, by the distributed ledger, a first mathematical function to the first data to generate a first mathematical output; storing, in the distributed ledger, the first unique identifier and at least one parameter of the said first mathematical function; and creating an updated digital twin of the at least one IoT device by updating data associated with a previous digital twin of the IoT device based on the first data.

According to a second aspect of this disclosure, a system is provided for managing data transmitted by at least one IoT device in a communication network, the system comprising: a non-transitory memory storing executable instructions; and one or more processors in communication with the non-transitory memory, wherein the one or more processors are configured to execute the executable instructions to at least: store a first data transmitted by the at least one IoT device to a distributed ledger; assign, by the distributed ledger, a first unique identifier to the first data; apply, by the distributed ledger, a first mathematical function to the first data to generate a first mathematical output; store, in the distributed ledger, the first unique identifier and at least one parameter of the said first mathematical function; and create an updated digital twin of the at least one IoT device by updating data associated with a previous digital twin of the IoT device based on the first data.

The teachings of this disclosure will be discussed, by way of non-limiting examples, with reference to the accompanying drawings, in which:

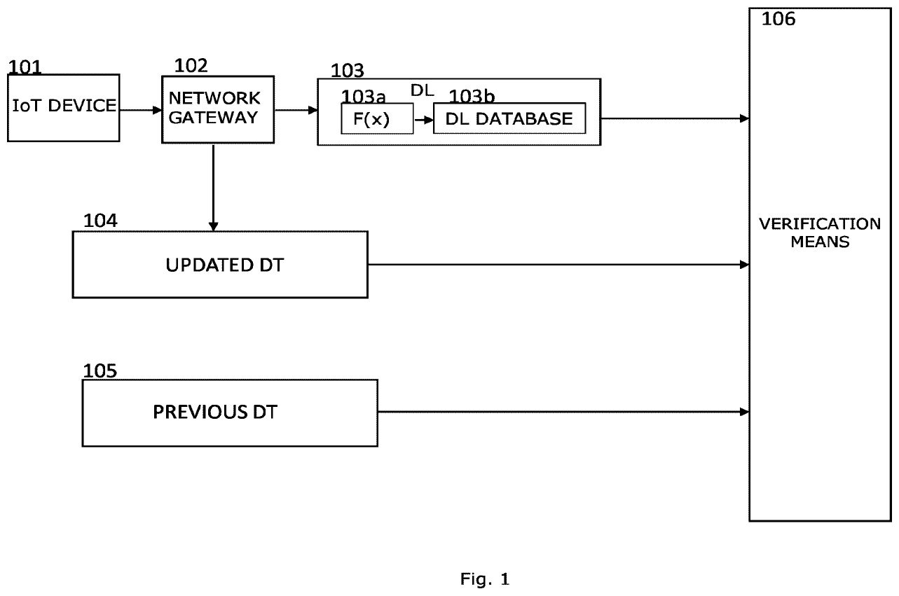

FIG. 1 shows a block diagram depicting the data flow between entities in an IoT environment for implementing a method according to an embodiment of this disclosure.

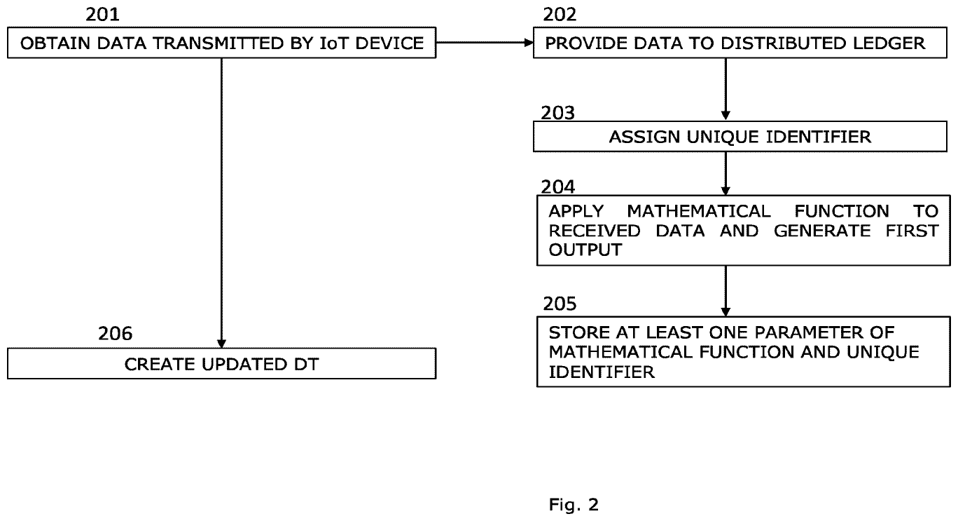

FIG. 2 shows a flow-chart of a method for managing data transmitted by an IoT device via a network gateway in a communication network, according to an embodiment of this disclosure.

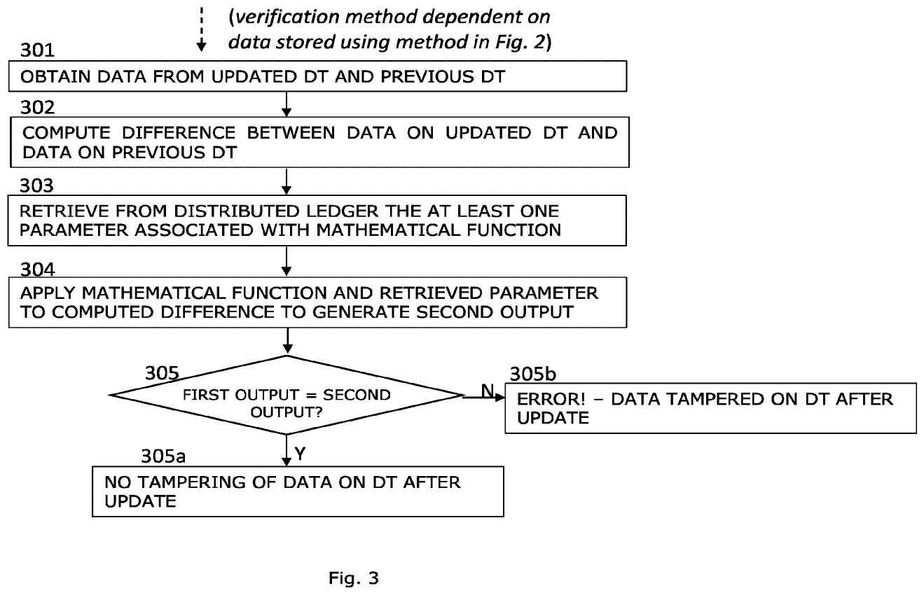

FIG. 3 shows the steps involved in a method for verification of the integrity of data on the updated DT, according to an embodiment of this disclosure.

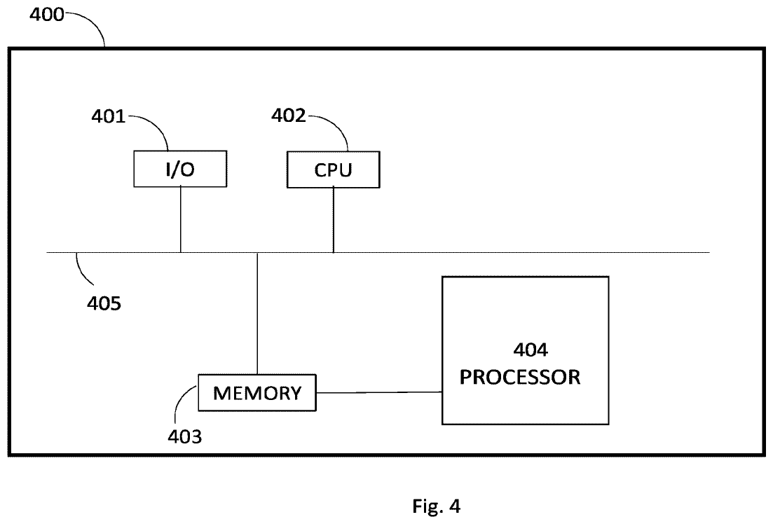

FIG. 4 shows an example computer system for executing the methods of FIG. 2 and/or FIG. 3.

The present invention provides a more secure and efficient method and system for management of constrained internet of things (IoT) devices. In particular, the present invention combines the advantages of digital twinning (DT) and distributed ledger technologies (DLT) to improve the management of IoT devices by providing security at a scale focusing on battery and computing power of constrained IoT devices.

We will first discuss the different entities in a generic IoT environment for implementing a method according to the present invention. The method itself will be discussed later in the description with respect to FIG. 2.

FIG. 1 shows a block diagram depicting the data flow between entities in an IoT environment for implementing a method according to an embodiment of this disclosure (see FIG. 2).

As seen in FIG. 1, the data from the IoT device 101 is transmitted in a communication network (for example, a LAN) via the network gateway 102 to a distributed ledger (DL) 103. The IoT device may be, for example, a physical sensor. The DL 103 is preferably implemented as a blockchain. The DL 103 processes received data as will be described in detail later with respect to FIG. 2, to generate a first output which is passed to a verification means 106. The network gateway 102 also creates an updated digital twin (DT) 104 based on the latest data obtained from the IoT device 101. The verification means 106 verifies the integrity of the data on the updated DT 104. For this purpose, the verification means 106 has access to the data in the updated DT 104, the data in the previous DT 105 (that is, the DT with data before the update by the network gateway) and the output from the DL 103. The verification means 106 can also retrieve other information stored in the DL used for purposes of processing the data received by the DL. In one embodiment, the verification means can refer to the end-user who uses the information accessed by the verification means to verify the integrity of the data on the update DT 104. In another embodiment, the verification means can be integrated as part of the DL itself, for example, as a smart contract in a blockchain having instructions for carrying out the verification of the integrity of the data on the updated DT 104.

FIG. 2 shows a flow-chart of a method according to an embodiment of this disclosure. The steps of the method will now be described with reference to the entities in FIG. 1. In step 201, the data transmitted by the IoT device 101 is received by the network gateway 102. In step 202, the network gateway provides the data to the DL 103. In step 203, the DL 103 assigns a unique identifier to the data received by the DL 103 and in step 204, the DL 103 applies a mathematical function (F(x)) 103a, to the received data to generate a first mathematical output. The mathematical function 103a can be any function which guarantees the generation of a unique output for every input. In one example, the mathematical function can be a multiplication operation by a prime number. In step 205, the DL 103 stores at least the unique identifier and at least one parameter of the mathematical function 103a in the DL database 103b. The DL 103 may optionally store the generated mathematical output in an encoded form on the DL database 103b. In step 206, which is carried out in parallel to steps 202-205, the network gateway creates, an updated DT 206 of the IoT device by updating data associated with a previous DT of the IoT device based on the latest data transmitted by the IoT device.

The DL 103 may preferably be implemented as a blockchain. In a blockchain implementation, the data received by the blockchain 103 from the network gateway 102, is signed using blockchain scripts (for example, smart contracts in the blockchain) to provide the unique identifier for the data and generate the above-described mathematical output. For example, where the mathematical operation is a multiplication by a prime number, the prime number or other parameter of the mathematical function is stored securely and immutably into the blockchain together with the unique identifier. That is, the skilled person in the art will understand that storing in the blockchain means storing the unique identifier and hashed data onto a block, with each block linked to a further block by a hashed pointer of that block. In some embodiments, the output of the function itself can also be stored in the blockchain.

The above-described method in FIG. 2, which combines digital twinning with distributed ledger technologies, enables the verification of the integrity of data on the updated DT of the IoT device. FIG. 3 shows the steps involved in a method for verification of the integrity of data on the updated DT. This method depends on the method of FIG. 2 in that it requires the retrieval of data stored on the updated DT 104 and the DL 103. In step 301 of FIG. 3, the verification means 106 (see FIG. 1) accesses data from the updated DT 104 and a previous DT 105. The verification means 106 then computes a difference between the data on the updated DT 104 and the data on the previous DT 105 (step 302). In step 303, the verification means 106 retrieves, from the DL 103, the at least one parameter associated with the mathematical function which was applied to the data received by the DL 103—this is the same data which was used by the network gateway 102 to create the updated DT 104 of the IoT device. The verification means 106 is able to identify the specific mathematical function applied to the data by referring to the unique identifier assigned to the data by the DL 103. For example, where the verification means 106 identifies that the mathematical function applied to the data (identified by the unique identifier assigned to the data by the DL 103) is a multiplication by prime number, the verification means 106 retrieves the prime number value stored on the DL 103. In step 304, the verification means 106 applies the mathematical function to the computed difference in data (step 302) to generate a second mathematical output. In step 305, the verification means 106 compares the first mathematical output to the second mathematical output to check the integrity of the data on the updated DT 104. That is, in step 305, the verification means 106 checks if the data on the updated DT 104 has been tampered with after the update by the network gateway 102. If the first output is equal to the second output (see step 205a) then the verification means 106 is able to conclude that there has been no tampering of data on the updated DT 104. If, however, the first output is not equal to the second output, the verification means 106 concludes that there is an error as the data has been tampered on the updated DT 104 (see step 205b). In the latter case, if, for example, the DL 103 is implemented as a blockchain, the previous unique identifier can be accessed together with the associated mathematical function and parameters to recreate the blockchain to avoid the loss of all historical data.

As mentioned before, in one embodiment, the verification means can refer to the end-user who uses the method of FIG. 3 to verify the integrity of the data on the update DT 104. In another embodiment, the verification means can be integrated as part of the DL itself, for example, as a smart contract in a blockchain having instructions according to the method in FIG. 3, for carrying out the verification of the integrity of the data on the updated DT 104.

In one embodiment, the mathematical function can be a dynamic function thereby improving the security of the data stored on the DL 103. For example, the mathematical function may at one point in time be a multiplication function, but it could, at another point in time be a convolution function (as used for example, in signal processing technologies). An encrypted file stored on the DL 103 could contain information as to how the function is dynamically set over time. In another example, the function could be dynamically based on the MAC addresses of the IoT device. In a blockchain implementation, the smart contract in the blockchain would inform the verification means 106 as to which function is associated with the data identified by the verification means 106 based on the unique identifier.

In this way, the method of FIG. 2 provides for security of data transmitted by a constrained IoT device at a scale focusing on battery and computer power of the device. The method has the key advantage of reducing the networking requirement of IoT devices by performing heavy security operations on a cloud service (that is, via the use of DT and DLTs). It uniquely combines digital twinning and DLT to enable efficient management of data transmitted by a constrained IoT device. Moreover, the method of FIG. 2 also enables verification of the integrity of data on an updated DT 104 of the IoT device 101 by enabling a verification means 106 to access data stored on the DL 103 and perform a verification method as described in FIG. 3.

In this way, the verification means 106 is able to safely verify that the data held by the updated DT 104 is what the gateway updated, and hence there is no tampering/losing to the data.

In some embodiments, the protocols/APIs used to exchange data with the methods as described above are secured on the enhanced gateways, where outgoing communications are completed over a virtual private network (VPN). Furthermore, data from processes, assets or systems that are being fed to a digital twin are also covered by the immutability of the above-described methods under the same operational principles as described above. The method of the present invention, therefore, offers end-users the ability to perform digital twinning of physical assets, devices, processes, and systems while being able to verify the integrity of the data transmitted by the IoT via crypto operations, such as those implemented in a blockchain.

While the above methods have been described with respect to data transmitted by a single IoT device, the methods can be extended to include data transmitted by a plurality of IoT devices.

The methods described above (for example, in FIGS. 2 and 3) may be implemented using a computer system including one or more processors and a non-transitory media. FIG. 4 shows an example of a computer system 400 comprising a processor 404 operable to execute machine code instructions stored in a non-transitory media, for example, a computer memory 406. The method as described in FIGS. 2 and 3 may be stored as executable instructions in the memory 406 that when executed by one or more processors cause various functions to be performed, such as the acts recited in the embodiments. By means of a general-purpose bus 408, an end-user operable input/output device 401 is capable of communication with the processor 404. The user operable input device 402 comprises, for example, a keyboard and/or a touchpad, a mouse or other pointing device, a contact sensitive surface on a display unit of a computer terminal, a writing tablet, speech recognition means, haptic input means, or any other means by which a user input action can be interpreted and converted into data signals.

Whilst the disclosure is particularly useful for management and verification of data transmitted by IoT devices, it is not limited to this application and may be equally useful for any application where the authenticity of data transmitted in a network is required to be verified.

### REFERENCES

[1] Patent Document 1: KR20220072657A, “IoT security construction method for IoT devices platform and security construction system for IoT devices platform based on dual blockchain coupled with virtual blockchain”
[2] Patent Document 2: US20210158307A1, “Blockchain ledger entry upon maintenance of asset and anomaly detection correction”
[3] “Blockchain Checksum for Establishing Secure Communications for Digital Twin Technology (November 2021)”, DOI: 10.1109/NAPS52732.2021.9654790

1. A computer-implemented method for managing data transmitted by at least one IoT device via a network gateway in a communication network, the method comprising:
providing, by the network gateway, a first data transmitted by the IoT device to a distributed ledger;
assigning, by the distributed ledger, a first unique identifier to the first data;
applying, by the distributed ledger, a first mathematical function to the first data to generate a first mathematical output;
storing, in the distributed ledger, the first unique identifier and at least one parameter of the said first mathematical function; and
creating an updated digital twin of the at least one IoT device by updating data associated with a previous digital twin of the IoT device based on the first data.

2. A computer-implemented method according to claim 1, further comprising:
verifying the data on the updated digital twin by:
computing a difference between data on the updated digital twin and the data on the previous digital twin;
retrieving, from the distributed ledger, the at least one parameter associated with the first mathematical function and applying the first mathematical function to the computed difference in data to generate a second mathematical output; and
comparing the first mathematical output and the second mathematical output to verify data on updated digital twin.

3. A computer-implemented method according to claim 1, wherein the method further comprises storing the first mathematical output in the distributed ledger.

4. A computer-implemented method according to claim 1, wherein the first mathematical function is a multiplication function and the at least one parameter is a prime number.

5. A computer-implemented method according to claim 1, wherein the first mathematical function is a dynamic function.

6. A computer-implemented method according to claim 5, wherein the dynamic function is based on a MAC address of the IoT device.

7. A computer-implemented method according to claim 1, wherein the distributed ledger is implemented as a blockchain.

8. A system for managing data transmitted by at least one IoT device in a communication network, the system comprising:
a non-transitory memory storing executable instructions; and
one or more processors in communication with the non-transitory memory, wherein the one or more processors are configured to execute the executable instructions to at least:
store a first data transmitted by the at least one IoT device to a distributed ledger;
assign, by the distributed ledger, a first unique identifier to the first data;
apply, by the distributed ledger, a first mathematical function to the first data to generate a first mathematical output;
store, in the distributed ledger, the first unique identifier and at least one parameter of the said first mathematical function; and
create an updated digital twin of the at least one IoT device by updating data associated with a previous digital twin of the IoT device based on the first data.

9. A system according to claim 8, wherein the one or more processors are further configured to execute the executable instructions to verify the data on the updated digital twin by:
computing a difference between data on the updated digital twin and the data on the previous digital twin;
retrieving, from the distributed ledger, the at least one parameter associated with the first mathematical function and applying the first mathematical function to the computed difference in data to generate a second mathematical output; and
comparing the first mathematical output and the second mathematical output.

10. A system according to claim 8, wherein the one or more processors are further configured to execute the executable instructions to store the first mathematical output in the distributed ledger.

11. A system according to claim 8, wherein the distributed ledger is configured to be implemented as a blockchain.

12. A system according to claim 11, wherein the blockchain comprises a smart contract configured to perform the said application of the mathematical function to the first data.

13. A system according to claim 11, wherein the blockchain comprises a smart contract configured to perform the verification of the data on the updated digital twin.

14. A system according to claim 8, wherein the first mathematical function is a multiplication function and the at least one parameter is a prime number.

15. A system according to claim 8, wherein the first mathematical function is a dynamic function.
